(19) United States
(12) Patent Application Publication
(10) Pub. No.: US 2025/0133503 A1
(43) Pub. Date: Apr. 24, 2025

(54) COMMUNICATION APPARATUS AND COMMUNICATION CONTROL METHOD

(71) Applicant: NIPPON TELEGRAPH AND TELEPHONE CORPORATION, Tokyo (JP)

(72) Inventors: Yoichi FUKADA, Musashino-shi, Tokyo (JP); Hiroaki KATSURAI, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/681,460

(22) PCT Filed: Aug. 10, 2021
(86) PCT No.: PCT/JP2021/029540

§ 371 Date: Feb. 5, 2024

(51) Int. Cl. H04W 52/02; H04W 76/28

(52) U.S. Cl. CPC H04W 52/0274; H04W 52/0216; H04W 76/28

(57) ABSTRACT

A communication device includes a communication unit that transmits and receives a signal to and from another communication device and a control unit that switches the communication unit from an idle state to an operating state by a reception timing of the signal, causes the communication unit to transmit the signal while the communication unit is in the operating state, and switches the communication unit from the operating state to the idle state after transmission/reception of the signal is performed.

### TECHNICAL FIELD

The present invention relates to a communication device and a communication control method.

### BACKGROUND ART

In recent years, a wide variety of objects have come to be connected to the Internet. Here, the term “object” means a device having a communication function unit (hereinafter referred to as a “terminal device”; a terminal device is an example of a communication device). In an Internet-of-things (IoT) system (for example, see FIG. 8) which is a service form in which such a terminal device transmits and receives information, a terminal device and an apparatus (for example, a sensor or the like serving as an information source) connected to the terminal device may be installed in a place where it is difficult to secure a commercial power source, for example, in the middle on a mountain. On the other hand, since a device that performs communication on the opposite side of the terminal device (hereinafter referred to as a “terminating device”; a terminating device is an example of a communication device) is mainly installed on site in a place such as a data center or a base station, it is relatively easy to secure a commercial power source in most cases. For example, the following two methods can be considered as methods for terminal devices to stably continue operations in such a communication environment.

The first method is a method of securing an alternative power source in place of a commercial power source. For example, a method of supplying power to a terminal device by using a primary battery is conceivable. However, in this case, if the primary battery is discharged, no power is supplied to the terminal device until the primary battery is replaced with a new one. In addition, for example, a method of supplying power to the terminal device by using environmental power generation (energy harvesting) such as a solar cell is conceivable. However, in the case of environmental power generation such as a solar cell, the amount of power supply is reduced in cloudy weather.

The second method is a method for reducing power consumption of a terminal device. If the power consumption of the terminal device can be reduced, for example, the life period of the primary battery before its discharge can be lengthened, so that the terminal device can continue to operate stably. Furthermore, if the power consumption of the terminal device can be reduced, the terminal device can operate even in a situation where the amount of power supply in the environmental power generation is reduced, for example, in cloudy weather, so that the terminal device can continue to operate stably.

For example, Non Patent Literature 1 and Non Patent Literature 2 disclose power-saving techniques for a case where a terminal device receives a signal. The goal of these power-saving techniques is to reduce power consumption of a terminal device by causing some or all of the functions of the terminal device to be in an operating state at the time of signal reception and causing the terminal device to be in an idle state at other times. Further, power consumption is high when the terminal device is in the operating state, and power consumption is low when the terminal device is in the idle state.

### CITATION LIST

### Non Patent Literature

[NPL 1] Masashi Tadokoro, et al., “Power-saving Technology for Network Equipment and Its Application-ONU/Wireless LAN Sleep Technology”, NTT Technology Journal, PP. 28-32, January 2014
[NPL 2] Hirotaka Ujikawa, et al., “Efforts to Reduce Power Consumption of Optical Access Communication Equipment”, NTT Technology Journal, PP. 32-35, January 2015

### SUMMARY OF INVENTION

### Technical Problem

Generally, when a terminal device transitions from an idle state to an operating state, the terminal device passes through a start-up state in the transition. The start-up state is a preparation period for changing the state of the terminal device from a state in which no signals can be transmitted or received to a state in which signals can be transmitted or received. While the terminal device is in the start-up state, power consumption becomes high although no signals can be transmitted or received.

In addition, one cycle of signal transmission and reception generally includes a start-up state associated with starting of a terminal device to transmit a signal and a start-up state associated with starting of the terminal device to receive a signal. For this reason, particularly in a case where a terminal device frequently transitions from an idle state to an operating state in the related art, the terminal device is frequently in a start-up state, and thus there is a problem that the provision of the idle state hinders the effect of lower power consumption of the terminal device.

The present invention has been made in view of the technical background described above, and an object of the present invention is to provide a communication device and a communication control method capable of achieving further reduction in power consumption for a communication device designed to achieve reduction in power consumption by providing an idle state.

### Solution to Problem

In addition, an aspect of the present invention is a communication device including a communication unit that transmits and receives a signal to and from another communication device, and a control unit that switches the communication unit from an idle state to an operating state by a reception timing of the signal, causes the communication unit to transmit the signal while the communication unit is in the operating state, and switches the communication unit from the operating state to the idle state after transmission/reception of the signal is performed.

In addition, an aspect of the present invention is a communication device including a communication unit that transmits and receives a signal to and from another communication device, and a control unit that causes the communication unit to transmit the signal at a transmission timing determined such that a reception timing of the other communication device for the signal is a timing at which the other communication device can receive the signal.

In addition, an aspect of the present invention is a communication control method including a communication step of transmitting and receiving a signal to and from another communication device, and a control step of switching a corresponding device from an idle state to an operating state by a reception timing of the signal, causing the corresponding device to transmit the signal while the corresponding device is in the operating state, and switching the corresponding device from the operating state to the idle state after transmission/reception of the signal is performed.

In addition, an aspect of the present invention is a communication control method including a communication step of transmitting and receiving a signal to and from another communication device, and a control step of causing a corresponding device to transmit the signal at a transmission timing determined such that a reception timing of the other communication device for the signal is a timing at which the other communication device can receive the signal.

### Advantageous Effects of Invention

According to the present invention, further reduction in power consumption can be realized in a communication device designed to achieve reduction in power consumption by providing an idle state.

### BRIEF DESCRIPTION OF DRAWINGS

FIG. 1 is a diagram illustrating forms of connection between terminal devices 1 and terminating devices 2 in a communication system according to a first embodiment of the present invention.

FIG. 2 is a block diagram illustrating a configuration of a terminal device 1 according to the first embodiment of the present invention.

FIG. 3 is a block diagram illustrating a configuration of a terminating device 2 according to the first embodiment of the present invention.

FIG. 4 is a diagram illustrating an operation of the terminal device 1 and the terminating device 2 and states of the terminal device 1 according to the first embodiment of the present invention.

FIG. 5 is a diagram illustrating an operation of a terminal device and a terminating device and states of the terminal device in the related art.

FIG. 6 is a diagram illustrating an operation of a terminal device 1 and a terminating device 2 and states of the terminal device 1 according to a second embodiment of the present invention.

FIG. 7 is a diagram illustrating an operation of a terminal device 1 and a terminating device 2 and states of the terminal device 1 according to a third embodiment of the present invention.

FIG. 8 is a diagram illustrating an example of a configuration of a general IoT system.

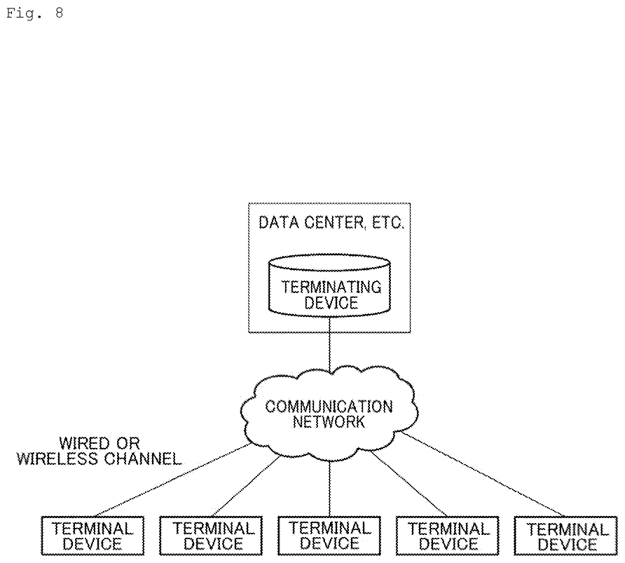

### DESCRIPTION OF EMBODIMENTS

Hereinafter, embodiments of the present invention will be described. Further, although a communication control method for an Internet-of-Things (IoT) terminal will be described as an example in each embodiment described below, the present invention is not limited thereto. For example, the communication control method of the present invention can be applied to various communication devices, for example, an optical network unit (ONU) of a passive optical network (PON) system. In addition, although a communication mode is the Internet as an example in each of the embodiments described below, the present invention is not limited thereto. For example, the communication control method of the present invention can be applied to various other communication modes such as communication by Ethernet and PON systems.

### First Embodiment

Hereinafter, a first embodiment of the present invention will be described with reference to the drawings.

[Form of Connection between Terminal Devices and Terminating Devices]

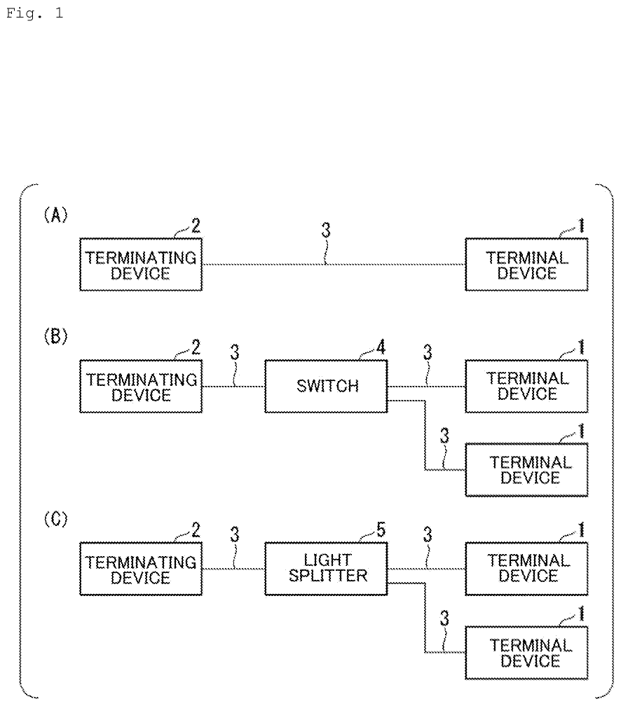

A form of connection between terminal devices and terminating devices in a communication system according to the present embodiment will be described. FIG. 1(A) to FIG. 1(C) are diagrams illustrating forms of connection between terminal devices 1 and terminating devices 2 in a communication system according to a first embodiment of the present invention.

As illustrated in FIG. 1(A) to FIG. 1(C), the communication system according to the present embodiment is a communication system in which a terminal device 1 and a terminating device 2 are connected by a transmission line 3 and can communicate with each other via the transmission line 3. FIG. 1(A) to FIG. 1(C) are diagrams each illustrating an example of a form of connection between the terminal devices 1 and the terminating devices 2, and the communication control method of the present invention can be applied to any form of connection.

For example, as illustrated in FIG. 1(A), the form of connection between the terminal device 1 and the terminating device 2 may be a form of connection in which only one terminal device 1 is connected to one terminating device 2. Alternatively, as illustrated in FIG. 1(B), for example, a form of connection between terminal devices 1 and a terminating device 2 may be a form of connection in which a switch 4 is provided in the middle of the transmission line 3 and a plurality of terminal devices 1 are connected to one terminating device 2. Alternatively, as illustrated in FIG. 1(C), for example, a form of connection between terminal devices 1 and a terminating device 2 may be a form of connection in which a light splitter 5 is provided in the middle of the transmission line 3 and a plurality of terminal devices 1 are connected to one terminating device 2.

In the following description, a propagation time of a signal in one direction between a terminal device 1 and a terminating device 2 will be represented by Δt_{access}. A value of Δt_{access} can be obtained, for example, by dividing the time required when a certain signal is propagated between the terminal device 1 and

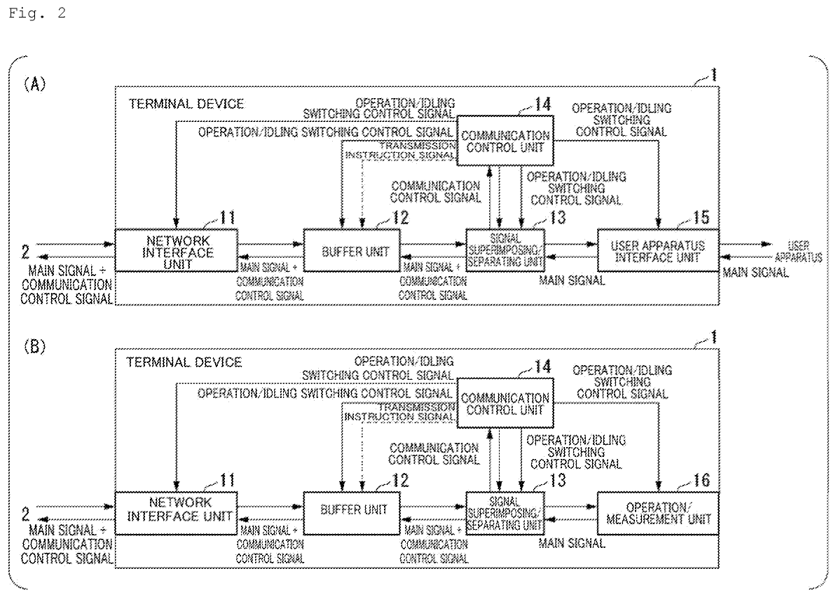

### The Terminating Device 2 in a Reciprocating Manner by 2.

[Configuration of Terminal Device]A configuration of a terminal device 1 according to the present embodiment will be described. FIG. 2(A) and FIG. 2(B) are block diagrams illustrating configurations of a terminal device 1 according to the first embodiment of the present invention. FIG. 2(A) and FIG. 2(B) are diagrams each illustrating an example of a configuration of the terminal device 1, and the communication control method of the present invention can be applied to the terminal device 1 having any configuration.

As illustrated in FIG. 2(A) and FIG. 2(B), the terminal device 1 includes a network interface unit 11, a buffer unit 12, and a communication control unit 14. The network interface unit 11 is connected to a terminating device 2 via the transmission line 3. The buffer unit 12 temporarily stores a signal. The communication control unit 14 controls switching of operation/idling of each unit of the terminal device 1 and controls signal transmission.

In a case in which the communication control unit 14 of the terminal device 1 transmits and receives information to and from a communication control unit 24 of the terminating device 2 on a communication control signal, the terminal device 1 includes a signal superimposing/separating unit 13 as illustrated in FIG. 2(A) and FIG. 2(B). The signal superimposing/separating unit 13 superimposes a communication control signal on a main signal. In addition, the signal superimposing/separating unit 13 separates a communication control signal from a main signal.

In addition, the terminal device 1 may further include a user apparatus interface unit 15 as necessary as illustrated in FIG. 2(A). The user apparatus interface unit 15 is a communication interface for transferring a main signal to a user apparatus.

In addition, the terminal device 1 may further include an operation/measurement unit 16 as necessary as illustrated in FIG. 2(B). The operation/measurement unit 16 performs display and operation based on a main signal received by the terminal device 1. Furthermore, the operation/measurement unit 16 places the result measured by, for example, a sensor (not shown) on the main signal transmitted from the terminal device 1.

Further, the terminal device 1 may include both the user apparatus interface unit 15 and the operation/measurement unit 16 if necessary.

The communication control unit 14 instructs at least one function unit among function units other than the communication control unit 14 included in the terminal device 1 to operate or idle using an operation/idling switching control signal. The function units other than the communication control unit 14 mentioned here are the network interface unit 11, the buffer unit 12, the signal superimposing/separating unit 13, the user apparatus interface unit 15, the operation/measurement unit 16, and other function units which are not illustrated.

Further, a function unit that is instructed to idle and brought into an idle state stops or reduces power supply to components related to signal transmission. Thus, the power consumption of the entire terminal device 1 is reduced. Further, the components related to signal transmission mentioned here are, for example, an internal light source, a photodiode, an amplifier, a signal reading circuit, a signal writing circuit, an arithmetic circuit, and the like.

Further, the buffer unit 12 needs to hold stored information (e.g., the main signal, the communication control signal, etc.) without erasing it even in the idle state. For this reason, for example, the memory storing information may be supplied with power at all times, or a nonvolatile memory capable of holding information even if power is not supplied may be used.

In addition, the communication control unit 14 instructs the buffer unit 12 to transmit an uplink signal based on a transmission instruction signal. The uplink signal mentioned here is a signal directed from the terminal device 1 to the terminating device 2, and is a main signal and a communication control signal superimposed on the main signal.

In addition, the communication control unit 14 communicates with the communication control unit 24 of the terminating device 2 using a communication control signal, and thereby information indicating a time slot in which the terminating device 2 may transmit a downlink signal (to the terminal device 1) is transmitted or received. Thus, the information indicating a time slot in which the terminating device 2 may transmit a downlink signal is shared by the terminal device 1 and the terminating device 2.

### [Configuration of Terminating Device]

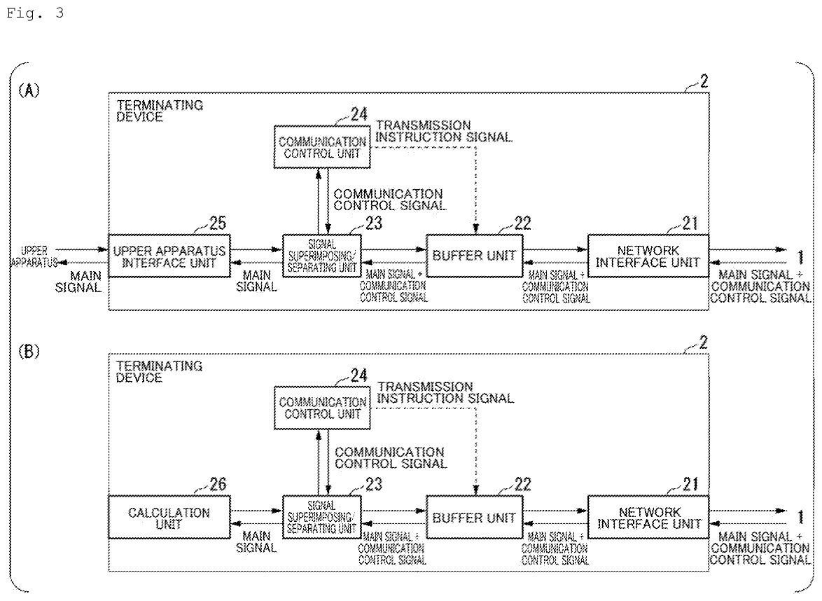

A configuration of a terminating device 2 according to the present embodiment will be described below. FIG. 3(A) and FIG. 3(B) are block diagrams illustrating configurations of a terminating device 2 according to the first embodiment of the present invention. FIG. 3(A) and FIG. 3(B) are diagrams each illustrating an example of a configuration of the terminating device 2, and the communication control method of the present invention can be applied to the terminating device 2 having any configuration.

The terminating device 2 includes a network interface unit 21, a buffer unit 22, and a communication control unit 24 as illustrated in FIG. 3(A) and FIG. 3(B). The network interface unit 21 is connected to a terminal device 1 via a transmission line 3. The buffer unit 22 temporarily stores a signal. The communication control unit 24 controls transmission of signals.

In a case in which the communication control unit 24 of the terminating device 2 transmits and receives information to and from the communication control unit 14 of the terminal device 1 on a communication control signal, the terminating device 2 includes the signal superimposing/separating unit 23 as illustrated in FIG. 3(A) and FIG. 3(B). The signal superimposing/separating unit 23 superimposes a communication control signal on a main signal. In addition, the signal superimposing/separating unit 23 separates a communication control signal from a main signal.

In addition, the terminating device 2 may further include an upper apparatus interface unit 25 as necessary as illustrated in FIG. 3(A). The upper apparatus interface unit 25 is a communication interface for transferring a main signal to an upper apparatus.

In addition, the terminating device 2 may further include a calculation unit 26, if necessary, as illustrated in FIG. 3(B). The calculation unit 26 performs display and signal processing based on the main signal received by the terminating device 2. Furthermore, the calculation unit 26 places an instruction to the terminal device 1 on a main signal transmitted from the terminating device 2.

Further, the terminating device 2 may include both the upper apparatus interface unit 25 and the calculation unit 26 if necessary.

The communication control unit 24 instructs the buffer unit 22 to transmit a downlink signal based on a transmission instruction signal. The downlink signal mentioned here is a signal directed from the terminating device 2 to the terminal device 1, and is a main signal and a communication control signal superimposed on the main signal.

In addition, the communication control unit 24 communicates with the communication control unit 14 of the terminal device 1 using a communication control signal, and thereby information indicating a time slot in which the terminating device 2 may transmit a downlink signal (to the terminal device 1) is transmitted or received. Thus, the information indicating a time slot in which the terminating device 2 may transmit a downlink signal is shared by the terminating device 2 and the terminal device 1.

Further, the information indicating the time slot in which the terminating device 2 may transmit a downlink signal may be generated by the terminating device 2 or the like and transmitted from the terminating device 2 to the terminal device 1 to be shared. Alternatively, the information indicating the time slot in which the terminating device 2 may be generated by the terminal device 1 or the like and transmitted from the terminal device 1 to the terminating device 2 to be shared.

[Operation of Terminal Device and Terminating Device]

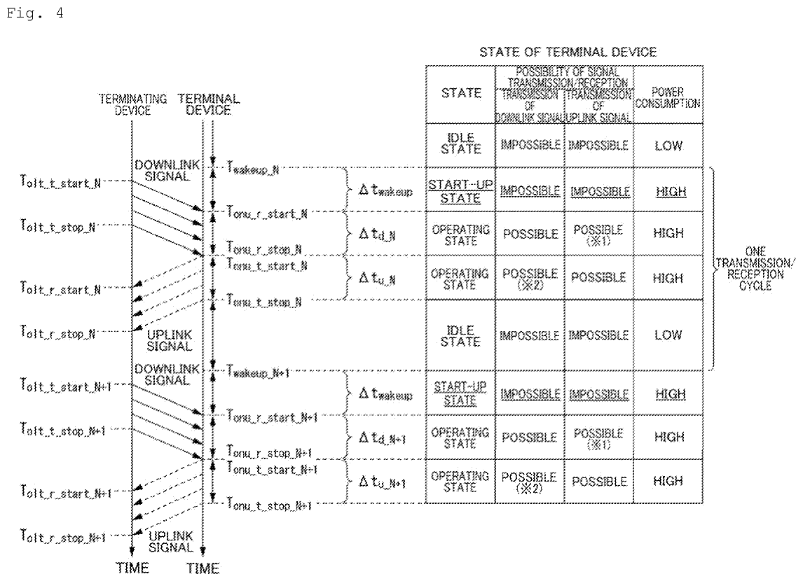

An operation of the terminal device 1 and the terminating device 2 according to the present embodiment will be described below. FIG. 4 is a diagram illustrating an operation of the terminal device 1 and the terminating device 2 and states of the terminal device 1 according to the first embodiment of the present invention.

In the present embodiment, a state of the terminal device 1 transitions to a start-up state, an operating state (a state in which a downlink signal can be received), an operating state (a state in which an uplink signal can be transmitted), and an idle state in this order in one transmission/reception cycle.

Here, each of signs is defined as follows.

Δt_{access}: A propagation time of a signal in one direction between the terminal device 1 and the terminating device 2.

Δt_{wakeup}: A start-up time of the terminal device 1 (a time in which the terminal device 1 is in the start-up state).

Δt_{d_N}: A time in which the terminal device 1 is in the operating state (the state in which a downlink signal can be received) in an N-th transmission/reception cycle.

Δt_{u_N}: A time in which the terminal device 1 is in the operating state (the state in which an uplink signal can be transmitted) in the N-th transmission/reception cycle.

T_{wakeup_N}: A start time of the start-up state of the terminal device 1 in the N-th transmission/reception cycle.

Among the above signs, values of Δt_{access} and Δt_{wakeup} are values determined based on characteristics of the transmission line 3 and the terminal device 1. On the other hand, values of Δt_{d_N}, Δt_{u_N}, and T_{wakeup_N} are values whose optimum values can vary depending on the residual power amount of the primary battery of the terminal device 1, and the values are generally dependent on a value of the number of transmission/reception cycles N.

Further, in general, when the residual power amount of the primary battery is small, it is conceivable that the power consumption should be reduced by reducing the values of Δt_{d_N} and Δt_{u_N} or increasing the value of T_{wakeup_N}. However, in the present invention, these values are not prescribed and may be arbitrary.

At this time, a transition timing for a state of the terminal device 1 can be represented by an expression such that, in the N-th transmission/reception cycle, the terminal device 1 starts up at a time T_{wakeup_N}, transitions to the operating state (the state in which a downlink signal can be received) at the time T_{wakeup_N}+Δt_{wakeup}, transitions to the operating state (the state in which an uplink signal can be transmitted) at the time T_{wakeup_N}+Δt_{wakeup}+Δt_{d_N}, and transitions to the idle state at the time T_{wakeup_N}+Δt_{wakeup}+Δt_{d_N}+Δt_{u_N}.

Further, the control of the state transition of the terminal device 1 is performed based on an instruction for operation or an instruction for idling from the communication control unit 14 of the terminal device 1. The communication control unit 14 issues an instruction for operation at the time T_{wakeup_N}, and the function unit that has received the instruction transitions from the idle state to the operating state via the start-up state. On the contrary, the communication control unit 14 issues an instruction for idling at the time T_{wakeup_N}+Δt_{wakeup}+Δt_{d_N}+Δt_{u_N}, and the function unit that has received the instruction transitions from the operating state to the idle state.

Reception of a downlink signal by the terminal device 1 is performed when the terminal device 1 is in the operating state (the state in which a downlink signal can be received). The operating conditions of the terminal device 1 and the terminating device 2 in this case can be expressed by the following expression (1) by using each sign defined as follows.

T_{onu_r_start_N}: A reception start time of the terminal device 1 for a downlink signal in an N-th transmission/reception cycle.

T_{onu_r_stop_N}: A reception end time of the terminal device 1 for a downlink signal in an N-th transmission/reception cycle.

T_{olt_t_start_N}: A transmission start time of the terminating device 2 for a downlink signal in an N-th transmission/reception cycle.

T_{olt_t_stop_N}: A transmission end time of the terminating device 2 for a downlink signal in an N-th transmission/reception cycle.

$${T}_{wakeup \_ N} + Δ {t}_{wakeup} ≦ {T}_{onu \_ r \_ start \_ N} < {T}_{onu \_ r \_ stop \_ N} ≦ {T}_{wakeup \_ N} + Δ {t}_{wakeup} + Δ {t}_{d \_ N} \qquad ( 1 )$$

Here, since T_{olt_t_start_N} and T_{olt_t_stop_N} can be represented by the following expressions (2) and (3), the above expression (1) is represented by the following expression (4).

$${T}_{olt \_ t \_ start \_ N} = {T}_{onu \_ r \_ start \_ N} - Δ {t}_{access} \qquad ( 2 )$$

$${T}_{olt \_ t \_ stop \_ N} = {T}_{onu \_ r \_ start \_ N} - Δ {t}_{access} \qquad ( 3 )$$

$${T}_{wakeup \_ N} + Δ {t}_{wakeup} - Δ {t}_{access} ≦ {T}_{olt \_ t \_ start \_ N} < {T}_{olt \_ t \_ stop \_ N} ≦ {T}_{wakeup \_ N} + Δ {t}_{wakeup} + Δ {t}_{d \_ N} - Δ {t}_{access} \qquad ( 4 )$$

That is, the terminating device 2 control transmission such that a downlink signal is transmitted in an N-th transmission/reception cycle during the time from the transmission start time T_{wakeup_N}+Δt_{wakeup}−Δt_{access} to the transmission end time T_{wakeup_N}+Δt_{wakeup}+Δt_{d_N}−Δt_{access}. Thus, when the terminal device 1 is in an operating state (the state in which a downlink signal can be received), the terminal device 1 receives the downlink signal.

Further, the control of the transmission start and the transmission end of the downlink signal in the terminating device 2 is performed by the communication control unit 24 by controlling the buffer unit 22. The buffer unit 22 is controlled such that the buffer unit outputs the downlink signal only between the transmission start time and the transmission end time and stores transmission data in other times.

Transmission of an uplink signal by the terminal device 1 is performed when the terminal device 1 is in the operating state (the state in which an uplink signal can be transmitted). The operating conditions of the terminal device 1 and the terminating device 2 in this case can be expressed by the following expression (5) by using each sign defined as follows.

T_{onu_t_start_N}: A transmission start time of the terminal device 1 for an uplink signal in an N-th transmission/reception cycle.

T_{onu_t_stop_N}: A transmission end time of the terminal device 1 for an uplink signal in an N-th transmission/reception cycle.

T_{olt_r_start_N}: A reception start time of the terminating device 2 for an uplink signal in an N-th transmission/reception cycle.

T_{olt_r_stop_N}: A reception end time of the terminating device 2 for an uplink signal in an N-th transmission/reception cycle.

$${T}_{wakeup \_ N} + Δ {t}_{wakeup} + Δ {t}_{d \_ N} ≦ {T}_{onu \_ t \_ start \_ N} < {T}_{onu \_ t \_ stop \_ N} \qquad ( 5 )$$

Here, since T_{olt_r_start_N} and T_{olt_r_stop_N} can be represented by the following expressions (6) and (7), the above expression (5) is represented by the following expression (8).

$${T}_{olt \_ r \_ start \_ N} = {T}_{onu \_ t \_ start \_ N} + Δ {t}_{access} \qquad ( 6 )$$

$${T}_{olt \_ r \_ stop \_ N} = {T}_{onu \_ t \_ start \_ N} + Δ {t}_{access} \qquad ( 7 )$$

$${T}_{wakeup \_ N} + Δ {t}_{wakeup} + Δ {t}_{d \_ N} + Δ {t}_{acces} ≦ {T}_{olt \_ r \_ start \_ N} < {T}_{olt \_ r \_ stop \_ N} ≦ {T}_{wakeup \_ N} + Δ {t}_{wakeup} + Δ {t}_{d \_ N} + Δ {t}_{u \_ N} + Δ {t}_{access} \qquad ( 8 )$$

That is, the terminal device 1 may control transmission such that an uplink signal is transmitted in an N-th transmission/reception cycle during the time from the transmission start time T_{wakeup_N}+Δt_{wakeup}+Δt_{d_N} to the transmission end time T_{wakeup_N}+Δt_{wakeup}+Δt_{d_N}+Δt_{u_N}. Thus, when the terminal device 1 is in the operating state (the state in which an uplink signal can be transmitted), the terminal device 1 transmits the uplink signal.

Further, the control of the transmission start and the transmission end of the uplink signal in the terminal device 1 is performed by the communication control unit 14 by controlling the buffer unit 12. The buffer unit 12 is controlled such that the buffer unit outputs the uplink signal only between the transmission start time and the transmission end time and stores transmission data in other times.

Further, although “possible” is described in the field indicated by (※1) in FIG. 4, in a case in which the terminal device 1 is configured to idle the function of transmitting an uplink signal, the field has “impossible”. In addition, although “possible” is described in the field indicated by (※2) in FIG. 4, in a case in which the terminal device 1 is configured to idle the function of transmitting a downlink signal, the field has “impossible”.

As illustrated in FIG. 4, the state of the terminal device 1 in the first embodiment continuously transitions from the start-up state to the operating state (the state in which a downlink signal can be received) and the operating state (the state in which an uplink signal can be transmitted) in one transmission/reception cycle. For this reason, in one transmission/reception cycle, the state of the terminal device 1 enters the start-up state that requires high power consumption only once although reception and transmission of the signals by the terminal device 1 are performed respectively.

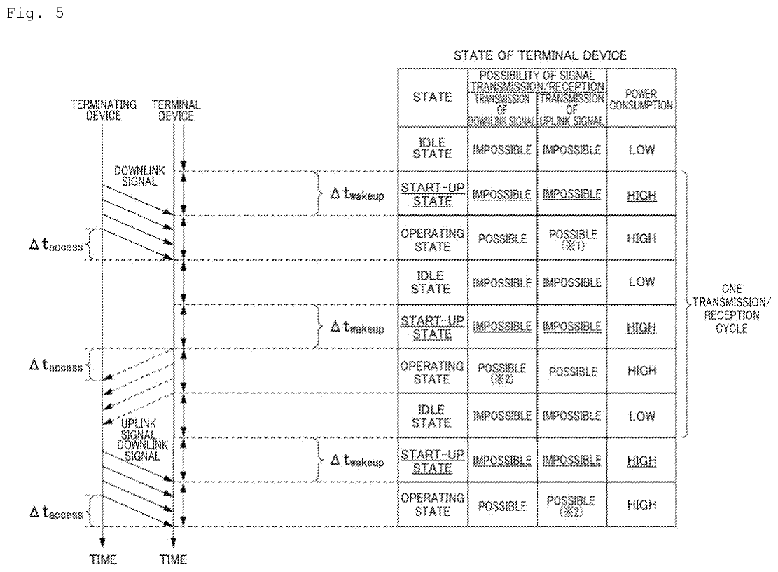

On the other hand, a case of the related art in which the state of the terminal device does not continuously transition from the start-up state to the operating state (the state in which a downlink signal can be received) and the operating state (the state in which an uplink signal can be transmitted) in one transmission/reception cycle is as illustrated in FIG. 5. FIG. 5 is a diagram illustrating an operation of a terminal device and a terminating device and states of the terminal device in the related art. In the case of the related art, a state of the terminal device being the start-up state that requires high power consumption occurs twice as illustrated in FIG. 5.

Further, although “possible” is described in the field indicated by (※1) in FIG. 5, in a case in which the terminal device 1 is configured to idle the function of transmitting an uplink signal, the field has “impossible”. In addition, although “possible” is described in the field indicated by (※2) in FIG. 5, in a case in which the terminal device 1 is configured to idle the function of transmitting a downlink signal, the field has “impossible”.

As described above, the communication system according to the first embodiment has the configuration in which the operating state (the state in which a downlink signal can be received) and the operating state (the state in which an uplink signal can be transmitted) of the terminal device 1 are made continuous and reception of a downlink signal and transmission of an uplink signal are performed in the respective operating states. With such a configuration, the communication system according to the first embodiment can reduce the period (number of times) in which the terminal device 1 enters the start-up state that requires high power consumption, and thereby low power consumption of the terminal device 1 can be achieved.

### Second Embodiment

Hereinafter, a second embodiment of the present invention will be described with reference to the drawings. Further, because a communication system according to the second embodiment has the similar form of connection between the terminal device 1 and the terminating device 2, configuration of the terminal device 1, and configuration of the terminating device 2 to those of the first embodiment, description thereof is omitted.

### [Operation of Terminal Device and Terminating Device]

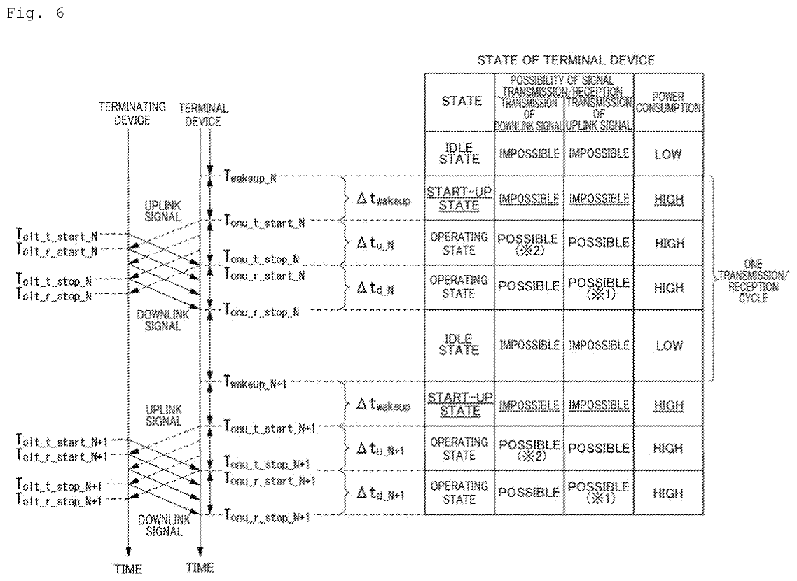

An operation of a terminal device 1 and a terminating device 2 according to the present embodiment will be described below. FIG. 6 is a diagram illustrating an operation of the terminal device 1 and the terminating device 2 and states of the terminal device 1 according to the second embodiment of the present invention.

In the present embodiment, a state of the terminal device 1 transitions to a start-up state, an operating state (a state in which an uplink signal can be received), an operating state (a state in which a downlink signal can be transmitted), and an idle state in this order in one transmission/reception cycle.

As described above, values of Δt_{access} and Δt_{wakeup} are values determined as characteristics of a transmission line 3 and the terminal device 1, respectively. On the other hand, values of Δt_{d_N}, Δt_{u_N}, and T_{wakeup_N} are values whose optimum values can vary depending on the residual power amount of the primary battery of the terminal device 1, and the values are generally dependent on a value of the number of transmission/reception cycles N.

Further, in general, when the residual power amount of the primary battery is small, it is conceivable that the power consumption should be reduced by reducing the values of Δt_{d_N} and Δt_{u_N} or increasing the value of T_{wakeup_N}. However, in the present invention, these values are not prescribed and may be arbitrary.

At this time, a transition timing for a state of the terminal device 1 can be represented by an expression such that, in an N-th transmission/reception cycle, the terminal device 1 starts up at a time T_{wakeup_N}, transitions to the operating state (the state in which an uplink signal can be transmitted) at a time T_{wakeup_N}+Δt_{wakeup}, transitions to the operating state (the state in which a downlink signal can be received) at a time T_{wakeup_N}+Δt_{wakeup}+Δt_{u_N}, and transitions to the idle state at a time T_{wakeup_N}+Δt_{wakeup}+Δt_{u_N}+Δt_{d_N}.

Further, the control of the state transition of the terminal device 1 is performed based on an instruction for operation or an instruction for idling from the communication control unit 14 of the terminal device 1. The communication control unit 14 issues an instruction for operation at the time T_{wakeup_N}, and the function unit that has received the instruction transitions from the idle state to the operating state via the start-up state. On the contrary, the communication control unit 14 issues an instruction for idling at the time T_{wakeup_N}+Δt_{wakeup}+Δt_{d_N}+Δt_{u_N}, and the function unit that has received the instruction transitions from the operating state to the idle state.

Transmission of an uplink signal by the terminal device 1 is performed when the terminal device 1 is in the operating state (the state in which an uplink signal can be transmitted). The operating conditions of the terminal device 1 and the terminating device 2 in this case can be expressed by the following expression (9).

$${T}_{wakeup \_ N} + Δ {t}_{wakeup} + Δ {t}_{u \_ N} ≦ {T}_{onu \_ t \_ start \_ N} < {T}_{onu \_ t \_ stop \_ N} ≦ {T}_{wakeup \_ N} + Δ {t}_{wakeup} + Δ {t}_{u \_ N} + Δ {t}_{d \_ N} \qquad ( 9 )$$

Here, since T_{olt_r_start_N} and T_{olt_r_stop_N} can be represented by the following expressions (6) and (7), the above expression (9) is represented by the following expression (10).

$${T}_{wakeup \_ N} + Δ {t}_{wakeup} + Δ {t}_{u \_ N} + Δ {t}_{acces} ≦ {T}_{olt \_ r \_ start \_ N} < {T}_{olt \_ r \_ stop \_ N} ≦ {T}_{wakeup \_ N} + Δ {t}_{wakeup} + Δ {t}_{u \_ N} + Δ {t}_{d \_ N} + Δ {t}_{access} \qquad ( 10 )$$

That is, the terminal device 1 may control transmission such that an uplink signal is transmitted in an N-th transmission/reception cycle during the time from the transmission start time T_{wakeup_N}+Δt_{wakeup}−Δt_{u_N} to the transmission end time T_{wakeup_N}+Δt_{wakeup}−Δt_{u_N}+Δt_{d_N}. Thus, when the terminal device 1 is in the operating state (the state in which an uplink signal can be transmitted), the terminal device 1 transmits the uplink signal.

Further, the control of the transmission start and the transmission end of the uplink signal in the terminal device 1 is performed by the communication control unit 14 by controlling the buffer unit 12. The buffer unit 12 is controlled such that the buffer unit outputs the uplink signal only between the transmission start time and the transmission end time and stores transmission data in other times.

Reception of a downlink signal by the terminal device 1 is performed when the terminal device 1 is in the operating state (the state in which a downlink signal can be received). The operating conditions of the terminal device 1 and the terminating device 2 in this case can be expressed by the following expression (11).

$${T}_{wakeup \_ N} + Δ {t}_{wakeup} + Δ {t}_{u \_ N} ≦ {T}_{onu \_ r \_ start \_ N} < {T}_{onu \_ r \_ stop \_ N} ≦ {T}_{wakeup \_ N} + Δ {t}_{wakeup} + Δ {t}_{u \_ N} + Δ {t}_{d \_ N} \qquad ( 11 )$$

Here, since T_{olt_t_start_N} and T_{olt_t_stop_N} can be represented by the following expressions (2) and (3), the above expression (11) is represented by the following expression (12).

$${T}_{wakeup \_ N} + Δ {t}_{wakeup} + Δ {t}_{u \_ N} - Δ {t}_{acces} ≦ {T}_{olt \_ t \_ start \_ N} < {T}_{olt \_ t \_ stop \_ N} ≦ {T}_{wakeup \_ N} + Δ {t}_{wakeup} + Δ {t}_{u \_ N} + Δ {t}_{d \_ N} - Δ {t}_{access} \qquad ( 12 )$$

That is, the terminating device 2 control transmission such that a downlink signal is transmitted in an N-th transmission/reception cycle during the time from the transmission start time T_{wakeup_N}+Δt_{wakeup}−Δt_{u_N}−Δt_{access} to the transmission end time T_{wakeup_N}+Δt_{wakeup}−Δt_{u_N}+Δt_{d_N}−Δt_{access}. Thus, when the terminal device 1 is in an operating state (the state in which a downlink signal can be received), the terminal device 1 receives the downlink signal.

Further, the control of the transmission start and the transmission end of the downlink signal in the terminating device 2 is performed by the communication control unit 24 by controlling the buffer unit 22. The buffer unit 22 is controlled such that the buffer unit outputs the downlink signal only between the transmission start time and the transmission end time and stores transmission data in other times.

Further, although “possible” is described in the field indicated by (※1) in FIG. 6, in a case in which the terminal device 1 is configured to idle the function of transmitting an uplink signal, the field has “impossible”. In addition, although “possible” is described in the field indicated by (※2) in FIG. 6, in a case in which the terminal device 1 is configured to idle the function of transmitting a downlink signal, the field has “impossible”.

As illustrated in FIG. 6, the state of the terminal device 1 in the second embodiment continuously transitions from the start-up state to the operating state (the state in which an uplink signal can be transmitted) and the operating state (the state in which a downlink signal can be received) in one transmission/reception cycle. For this reason, in one transmission/reception cycle, the state of the terminal device 1 enters the start-up state that requires high power consumption only once although reception and transmission of the signals by the terminal device 1 are performed respectively.

On the other hand, in the case of the related art in which the state of the terminal device does not continuously transition from the start-up state to the operating state (the state in which an uplink signal can be transmitted) and the operating state (the state in which a downlink signal can be received) in one transmission/reception cycle, the state of the terminal device being the start-up state that requires high power consumption occurs twice as illustrated in FIG. 5 described above.

As described above, the communication system according to the second embodiment has the configuration in which the operating state (the state in which an uplink signal can be transmitted) and the operating state (the state in which a downlink signal can be received) of the terminal device 1 are made continuous and transmission of an uplink signal and reception of a downlink signal are performed in the respective operating states. With such a configuration, the communication system according to the second embodiment can reduce the period (number of times) in which the terminal device 1 enters the start-up state that requires high power consumption, and thereby low power consumption of the terminal device 1 can be achieved.

### Third Embodiment

Hereinafter, a third embodiment of the present invention will be described with reference to the drawings. Further, because a communication system according to the third embodiment has the similar form of connection between the terminal device 1 and the terminating device 2, configuration of the terminal device 1, and configuration of the terminating device 2 to those of the first embodiment, description thereof is omitted.

### [Operation of Terminal Device and Terminating Device]

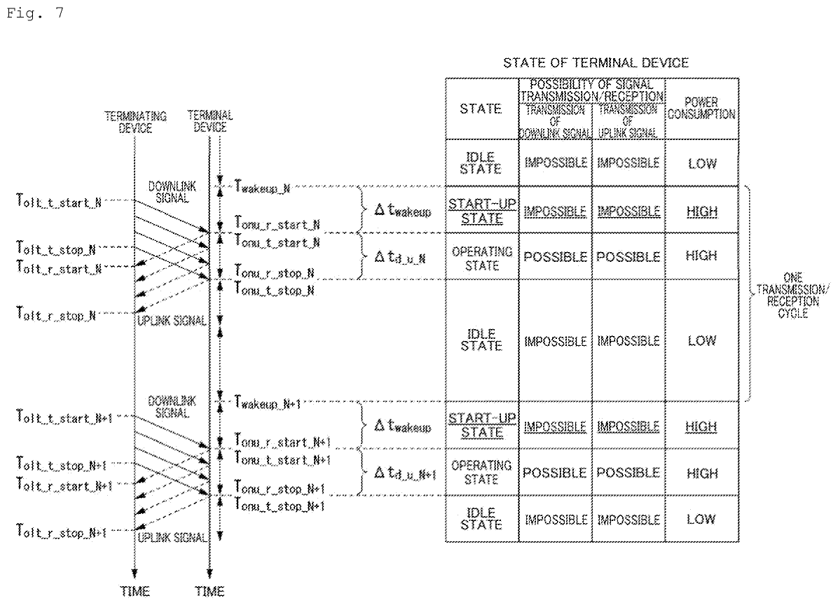

An operation of a terminal device 1 and a terminating device 2 according to the present embodiment will be described below. FIG. 7 is a diagram illustrating an operation of the terminal device 1 and the terminating device 2 and states of the terminal device 1 according to the third embodiment of the present invention.

In the present embodiment, a state of the terminal device 1 transitions to a start-up state, an operating state (a state in which a downlink signal can be received and an uplink signal can be transmitted), and an idle state in this order in one transmission/reception cycle.

Here, each of signs is defined as follows.

Δt_{d_u__N}: A time in which the terminal device 1 is in the operating state (the state in which a downlink signal can be received and an uplink signal can be transmitted) in an N-th transmission/reception cycle.

As described above, values of Δt_{access} and Δt_{wakeup} are values determined as characteristics of a transmission line 3 and the terminal device 1, respectively. On the other hand, values of Δt_{d_u_N} and T_{wakeup_N} are values whose optimum values can vary depending on the residual power amount of the primary battery of the terminal device 1, and the values are generally dependent on a value of the number of transmission/reception cycles N.

Further, in general, when the residual power amount of the primary battery is small, it is conceivable that the power consumption should be reduced by reducing the value of Δt_{d_u_N} and or increasing the value of T_{wakeup_N}. However, in the present invention, these values are not prescribed and may be arbitrary.

At this time, a transition timing for a state of the terminal device 1 can be represented by an expression such that, in the N-th transmission/reception cycle, the terminal device 1 starts up at the time T_{wakeup_N}, transitions to the operating state (the state in which a downlink signal can be received and an uplink signal can be transmitted) at the time T_{wakeup_N}+Δt_{wakeup}, and transitions to the idle state at the time T_{wakeup_N}+Δt_{wakeup}+Δt_{d_u_N}.

Further, the control of the state transition of the terminal device 1 is performed based on an instruction for operation or an instruction for idling from the communication control unit 14 of the terminal device 1. The communication control unit 14 issues an instruction for operation at the time T_{wakeup_N}, and the function unit that has received the instruction transitions from the idle state to the operating state via the start-up state. On the contrary, the communication control unit 14 issues an instruction for idling at the time T_{wakeup_N}+Δt_{wakeup}−Δt_{d_u_N}, and the function unit that has received the instruction transitions from the operating state to the idle state.

Reception of a downlink signal by the terminal device 1 is performed when the terminal device 1 is in the operating state (the state in which a downlink signal can be received and an uplink signal can be transmitted). The operating conditions of the terminal device 1 and the terminating device 2 in this case can be expressed by the following expression (13).

$${T}_{wakeup \_ N} + Δ {t}_{wakeup} ≦ {T}_{onu \_ r \_ start \_ N} < {T}_{onu \_ r \_ stop \_ N} ≦ {T}_{wakeup \_ N} + Δ {t}_{wakeup} + Δ {t}_{d \_ u \_ N} \qquad ( 13 )$$

Here, since T_{olt_t_start_N} and T_{olt_t_stop_N} can be represented by the following expressions (2) and (3), the above expression (13) is represented by the following expression (14).

$${T}_{wakeup \_ N} + Δ {t}_{wakeup} - Δ {t}_{access} ≦ {T}_{olt \_ t \_ start \_ N} < {T}_{olt \_ t \_ stop \_ N} ≦ {T}_{wakeup \_ N} + Δ {t}_{wakeup} + Δ {t}_{d \_ u \_ N} - Δ {t}_{access} \qquad ( 14 )$$

That is, the terminating device 2 may control transmission such that a downlink signal is transmitted in an N-th transmission/reception cycle during the time from the transmission start time T_{wakeup_N}+Δt_{wakeup}−Δt_{access} to the transmission end time T_{wakeup_N}+Δt_{wakeup}+Δt_{d_u_N}−Δt_{access}. Thus, when the terminal device 1 is in the operating state (the state in which a downlink signal can be received and an uplink signal can be transmitted), the terminal device 1 receives the downlink signal.

Further, the control of the transmission start and the transmission end of the downlink signal in the terminating device 2 is performed by the communication control unit 24 by controlling the buffer unit 22. The buffer unit 22 is controlled such that the buffer unit outputs the downlink signal only between the transmission start time and the transmission end time and stores transmission data in other times.

Transmission of the uplink signal by the terminal device 1 is performed when the terminal device 1 is in the operating state (the state in which a downlink signal can be received and an uplink signal can be transmitted). The operating conditions of the terminal device 1 and the terminating device 2 in this case can be expressed by the following expression (15).

$${T}_{wakeup \_ N} + Δ {t}_{wakeup} ≦ {T}_{onu \_ r \_ start \_ N} < {T}_{onu \_ r \_ stop \_ N} ≦ {T}_{wakeup \_ N} + Δ {t}_{wakeup} + Δ {t}_{d \_ u \_ N} \qquad ( 15 )$$

Here, since T_{olt_r_start_N} and T_{olt_r_stop_N} can be represented by the following expressions (6) and (7), the above expression (15) is represented by the following expression (16).

$${T}_{wakeup \_ N} + Δ {t}_{wakeup} - Δ {t}_{access} ≦ {T}_{olt \_ r \_ start \_ N} < {T}_{olt \_ r \_ stop \_ N} ≦ {T}_{wakeup \_ N} + Δ {t}_{wakeup} + Δ {t}_{d \_ u \_ N} - Δ {t}_{access} \qquad ( 16 )$$

That is, the terminal device 1 may control transmission such that the terminal device 1 transmits an uplink signal in the N-th transmission/reception cycle during the time from the transmission start time T_{wakeup_N}+Δt_{wakeup} to the transmission end time T_{wakeup_N}+Δt_{wakeup}+Δt_{d_u_N}, and thus, when the terminal device 1 is in the operating state (the state in which a downlink signal can be received and an uplink signal can be transmitted), the terminal device 1 transmits the uplink signal.

Further, the control of the transmission start and the transmission end of the uplink signal in the terminal device 1 is performed by the communication control unit 14 by controlling the buffer unit 12. The buffer unit 12 is controlled such that the buffer unit outputs the uplink signal only between the transmission start time and the transmission end time and stores transmission data in other times.

As illustrated in FIG. 7, the state of the terminal device 1 in the third embodiment transitions from the start-up state to the operating state (the state in which a downlink signal can be received and an uplink signal can be transmitted) in one transmission/reception cycle. Since the transmission and reception of the signal by the terminal device 1 are performed at the same timing as described above, the state of the terminal device 1 being the start-up state that requires high power consumption occurs only once.

On the other hand, in the case of the related art in which the state of the terminal device does not continuously transition from the start-up state to the operating state (the state in which an uplink signal can be transmitted) and the operating state (the state in which a downlink signal can be received) in one transmission/reception cycle, the state of the terminal device being the start-up state that requires high power consumption occurs twice as illustrated in FIG. 5 described above.

As described above, the communication system according to the third embodiment has a configuration in which signals can be transmitted and received when the terminal device 1 is in the operating state (the state in which a downlink signal can be received and an uplink signal can be transmitted). With such a configuration, the communication system according to the third embodiment can reduce the period (number of times) in which the terminal device 1 enters the start-up state that requires high power consumption, and thereby low power consumption of the terminal device 1 can be achieved.

### Fourth Embodiment

A fourth embodiment of the present invention will be described below. It is assumed that a configuration of a communication system according to the fourth embodiment is used in combination with the configuration of the communication system according to any one of the first to third embodiments. Further, because the communication system according to the fourth embodiment has the similar form of connection between the terminal device 1 and the terminating device 2, configuration of the terminal device 1, and configuration of the terminating device 2 to those of the first embodiment, description thereof is omitted.

### [Operation of Terminal Device and Terminating Device]

An operation of a terminal device 1 and a terminating device 2 according to the present embodiment will be described below. As described in the first to third embodiments, in the present embodiment above, it is also necessary that the period during which the terminating device 2 transmits a downlink signal and the operating state of the terminal device 1 satisfy the relationship represented by any of the following expressions (17) to (19).
In combination with the configuration of the first embodiment

$${T}_{wakeup \_ N} + Δ {t}_{wakeup} - Δ {t}_{access} ≦ {T}_{olt \_ t \_ start \_ N} < {T}_{olt \_ t \_ stop \_ N} ≦ {T}_{wakeup \_ N} + Δ {t}_{wakeup} + Δ {t}_{d \_ N} - Δ {t}_{access} \qquad ( 17 )$$

In combination with the configuration of the second embodiment

$${T}_{wakeup \_ N} + Δ {t}_{wakeup} + Δ {t}_{u \_ N} - Δ {t}_{acces} ≦ {T}_{olt \_ t \_ start \_ N} < {T}_{olt \_ t \_ stop \_ N} ≦ {T}_{wakeup \_ N} + Δ {t}_{wakeup} + Δ {t}_{u \_ N} + Δ {t}_{d \_ N} - Δ {t}_{access} \qquad ( 18 )$$

In combination with the configuration of the third embodiment

$${T}_{wakeup \_ N} + Δ {t}_{wakeup} - Δ {t}_{access} ≦ {T}_{olt \_ t \_ start \_ N} < {T}_{olt \_ t \_ stop \_ N} ≦ {T}_{wakeup \_ N} + Δ {t}_{wakeup} + Δ {t}_{d \_ u \_ N} - Δ {t}_{access} \qquad ( 19 )$$

Further, the expression (17) is the same as the above expression (4), the above expression (18) is the same as the above expression (12), and the above expression (19) is the same as the above expression (14).

Here, the values of T_{wakeup_N}, Δt_{d_N}, Δt_{u_N}, and Δt_{d_u_N} in the above expressions (17) to (19) are values whose optimum values can vary depending on the residual power amount of the primary battery of the terminal device 1, and generally depend on the value of the number of transmission/reception cycles N. Similarly, values of T_{olt_t_start__N} and T_{olt_t_stop_N} are values whose request values can vary according to an information amount to be communicated by the terminating device 2, and generally depend on the value of the number of transmission/reception cycles N. In the present invention, these values are not prescribed and may be arbitrary.

However, in order that the terminal device 1 normally receives a downlink signal, even if each of the above-described values varies depending on the number of transmission/reception cycles N, the relationship between the terminal device 1 and the terminating device 2 represented by any of the expressions (17) to (19) needs to be satisfied.

Therefore, in the communication system of the present embodiment, the communication control unit 14 of the terminal device 1 and the communication control unit 24 of the terminating device 2 share information indicating a time slot in which the terminating device 2 may transmit a downlink signal in an (N+1)-th and subsequent transmission/reception cycles. The timing at which the communication control unit 14 of the terminal device 1 and the communication control unit 24 of the terminating device 2 share the information is the N-th transmission/reception cycle.

The communication control unit 14 of the terminal device 1 and the communication control unit 24 of the terminating device 2 share information by transmitting and receiving a signal by superimposing a communication control signal on a main signal. The communication control unit 14 of the terminal device 1 calculates the information using any of the expressions (17) to (19) with the values of T_{wakeup}, Δt_{d_N}, Δt_{u_N}, and Δt_{d_u_N}. Then, the communication control unit 14 of the terminal device 1 transmits the calculated information to the communication control unit 24 of the terminating device 2. Further, in this case, even if the communication control signal is transmitted only in the uplink direction, the minimum operation is possible.

As described above, the communication system according to the fourth embodiment has the configuration in which the communication control unit 14 of the terminal device 1 and the communication control unit 24 of the terminating device 2 share information indicating the time slot in which the terminating device 2 may transmit a downlink signal in the (N+1)-th transmission/reception cycle. By having such a configuration, in the communication system according to the fourth embodiment, the terminal device 1 can normally receive downlink signals even if the start time T_{wakeup_N} of the terminal device 1 in the start-up state and the times Δt_{d_N}, Δt_{u_N}, and Δt_{d_u_N} of the terminal device in the operating state vary for each transmission/reception cycle.

### Fifth Embodiment

A fifth embodiment of the present invention will be described below. Further, it is assumed that a configuration of a communication system according to the fifth embodiment is used in combination with the configuration of the communication system according to any one of the first to third embodiments. Further, because the communication system according to the fifth embodiment has the similar form of connection between the terminal device 1 and the terminating device 2, configuration of the terminal device 1, and configuration of the terminating device 2 to those of the first embodiment, description thereof is omitted.

### [Operation of Terminal Device and Terminating Device]

An operation of a terminal device 1 and a terminating device 2 according to the present embodiment will be described below. Similarly to the terminal device 1 and the terminating device 2 according to the fourth embodiment described above, the communication control unit 14 of the terminal device 1 and the communication control unit 24 of the terminating device 2 share information indicating a time slot in which the terminating device 2 may transmit a downlink signal in from an (N+1)-th and subsequent transmission/reception cycles as well in the present embodiment. The timing at which the communication control unit 14 of the terminal device 1 and the communication control unit 24 of the terminating device 2 share the information is the N-th transmission/reception cycle.

The communication control unit 14 of the terminal device 1 and the communication control unit 24 of the terminating device 2 share information by transmitting and receiving a signal by superimposing a communication control signal on a main signal. However, in the present embodiment, after the communication control unit 24 of the terminating device 2 generates the information and transmits it to the communication control unit 14 of the terminal device 1, T_{wakeup_N}, Δt_{d_N}, Δt_{u_N}, or Δt_{d_u_N} is determined to satisfy any of the above expressions (17) to (19). Further, in this case, even if a communication control signal is transmitted only in the downlink direction, the minimum operation is possible.

As described above, the communication system according to the fifth embodiment has the configuration in which the communication control unit 14 of the terminal device 1 and the communication control unit 24 of the terminating device 2 share information indicating the time slot in which the terminating device 2 may transmit a downlink signal in the (N+1)-th transmission/reception cycle. By having such a configuration, in the communication system according to the fifth embodiment, the terminal device 1 can normally receive downlink signals even if the start time T_{wakeup_N} of the terminal device 1 in the start-up state and the times Δt_{d_N}, Δt_{u_N}, and Δt_{d_u__N} of the terminal device in the operating state vary for each transmission/reception cycle.

According to the embodiments described above, a communication device has a communication unit and a control unit. For example, the communication device is the terminal device 1 according to the embodiments, the communication unit is at least one function unit among the function units included in the terminal device 1 other than the communication control unit 14 in the embodiments, and the control unit is the communication control unit 14 according to the embodiments.

The communication unit transmits and receives signals to and from another communication device. For example, the other communication device is the terminal device 1 of the embodiments. The control unit switches the communication unit from an idle state to an operating state before a signal reception timing, causes the communication unit to transmit a signal while the communication unit is in the operating state, and switches the communication unit from the operating state to the idle state after signal transmission/reception is performed.

Further, the communication device may further include a control information superimposing unit. For example, the control information superimposing unit is the signal superimposing/separating unit 13 of the embodiments. In this case, the control information superimposing unit superimposes control information on a signal transmitted from the communication unit. For example, the control information is the communication control signal of the embodiments. In addition, in this case, the control unit calculates the transmission timing at which the other communication device transmits a signal to receive the signal at the reception timing. In addition, in this case, the control information superimposing unit superimposes the control information indicating the transmission timing on the signal.

Further, the communication device may further include a control information acquiring unit. For example, the control information acquiring unit is the signal superimposing/separating unit 13 of the embodiments. In this case, the control information acquiring unit acquires the control information superimposed on the signal transmitted from the other communication device. For example, the control information is the communication control signal of the embodiments. In addition, in this case, the control unit specifies the reception timing based on the transmission timing at which the other communication device transmits the signal included in the control information.

According to the embodiments described above, a communication device has a communication unit and a control unit. For example, the communication device is the terminating device 2 according to the embodiments, the communication unit is the network interface unit 21 according to the embodiments, and the control unit is the communication control unit 24 according to the embodiments.

The communication unit transmits and receives signals to and from another communication device. For example, the other communication device is the terminal device 1 of the embodiments. The control unit causes the communication unit to transmit a signal at a transmission timing determined such that a reception timing at which the other communication device receives a signal is the timing at which the other communication device can receive a signal.

Further, the communication device may further include a control information acquiring unit. For example, the control information acquiring unit is the signal superimposing/separating unit 23 of the embodiments. In this case, the control information acquiring unit acquires the control information superimposed on the signal transmitted from the other communication device. For example, the control information is the communication control information of the embodiments. In addition, in this case, the control unit causes the communication unit to transmit a signal at the transmission timing based on the control information.

Further, the communication device may further include a control information superimposing unit. For example, the control information superimposing unit is the signal superimposing/separating unit 23 of the embodiments. In this case, the control information superimposing unit superimposes control information including information indicating the transmission timing on a signal transmitted from the communication unit. For example, the control information is the communication control information of the embodiments.

At least a part or all of the terminal device 1 or the terminating device 2 in each of the above-described embodiments may be realized by a computer. In such a case, a program for realizing this function may be recorded on a computer-readable recording medium, and the program recorded on the recording medium may be read and executed by a computer system. Further, the “computer system” recited herein includes an OS and hardware such as peripheral devices. In addition, the “computer-readable recording medium” refers to a portable medium such as a flexible disk, a magneto-optical disc, a ROM, or a CD-ROM, or a storage device such as a hard disk built into the computer system. Furthermore, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system serving as a server or a client in such a case. Moreover, the program described above may be any of a program for realizing some of the functions described above, a program capable of realizing the foregoing functions in combination with a program already recorded in a computer system, and a program that is realized using a programmable logic device such as an FPGA (Field Programmable Gate Array).

Although the embodiment of the present invention has been described in detail with reference to the drawings, a specific configuration is not limited to this embodiment, and design within the scope of the gist of the present invention, and the like are included.

The following supplementary notes are disclosed in relation to the communication system introduced in each of the embodiments described above.

### (Supplementary Note 1)

A communication device including a communication unit that transmits and receives a signal to and from another communication device, and a control unit that switches the communication unit from an idle state to an operating state by a reception timing of the signal, causes the communication unit to transmit the signal while the communication unit is in the operating state, and switches the communication unit from the operating state to the idle state after transmission/reception of the signal is performed.

### (Supplementary Note 2)

The communication device described in Supplementary Note 1 further including a control information superimposing unit that superimposes control information on the signal transmitted from the communication unit,
in which
the control unit calculates a transmission timing of the other communication device for the signal to receive the signal at the reception timing, and
the control information superimposing unit superimposes the control information indicating the transmission timing on the signal.

### (Supplementary Note 3)

The communication device described in Supplementary Note 1 further including a control information acquiring unit that acquires control information superimposed on the signal transmitted from the other communication device,
in which
the control unit specifies the reception timing based on the transmission timing of the other communication device for the signal included in the control information.

### (Supplementary Note 4)

A communication device including a communication unit that transmits and receives a signal to and from another communication device, and
a control unit causes the communication unit to transmit the signal at a transmission timing determined such that a reception timing of the other communication device for the signal is a timing at which the other communication device can receive the signal.

### (Supplementary Note 5)

The communication device described in Supplementary Note 4 further including a control information acquiring unit that acquires control information superimposed on the signal transmitted from the other communication device,
in which
the control unit causes the communication unit to transmit the signal at the transmission timing based on the control information.

### (Supplementary Note 6)

The communication device described in Supplementary Note 4 further including a control information superimposing unit that superimposes control information including information indicating the transmission timing on the signal transmitted from the communication unit.

### (Supplementary Note 7)

A communication control method including a communication step of transmitting and receiving a signal to and from another communication device, and
a control step of switching a corresponding device from an idle state to an operating state by a reception timing of the signal, causing the corresponding device to transmit the signal while the corresponding device is in the operating state, and switching the corresponding device from the operating state to the idle state after transmission/reception of the signal is performed.

### (Supplementary Note 8)

A communication control method including a communication step of transmitting and receiving a signal to and from another communication device, and
a control step of causing a corresponding device to transmit the signal at a transmission timing determined such that a reception timing of the other communication device for the signal is a timing at which the other communication device can receive the signal.

### (Supplementary Note 9)

The communication device described in Supplementary Note 2 in which the transmission timing is a timing at which the signal is transmitted in an N-th transmission/reception cycle during the time from a transmission start time T_{wakeup_N}+Δt_{wakeup}+Δt_{d_N} to a transmission end time T_{wakeup_N}+Δt_{wakeup}+Δt_{d_N}+Δt_{u_N}.

Where,
T_{wakeup_N} is a start time of a start-up state of the corresponding device in the N-th transmission/reception cycle in which a transition is made from the idle state to the operating state,
Δt_{wakeup} is a period in which the corresponding device is in the start-up state,
Δt_{d_N} is a period in which the corresponding device is in the operating state in which the signal can be received in the N-th transmission/reception cycle, and
Δt_{u_N} is a period in which the corresponding device is in the operating state in which the signal can be transmitted in the N-th transmission/reception cycle.

### (Supplementary Note 10)

The communication device described in Supplementary Note 2 in which the transmission timing is a timing at which the signal is transmitted in the N-th transmission/reception cycle during the time from a transmission start time T_{wakeup_N}+t_{wakeup}+Δt_{u_N}−Δt_{access} to a transmission end time T_{wakeup_N}+Δt_{wakeup}+Δt_{u_N}+Δt_{d_N}−Δt_{access}.

Where,
T_{wakeup_N} is a start time of a start-up state of the corresponding device in the N-th transmission/reception cycle in which a transition is made from the idle state to the operating state,
Δt_{wakeup} is a period in which the corresponding device is in the start-up state,
Δt_{d_N} is a period in which the corresponding device is in the operating state in which the signal can be received in the N-th transmission/reception cycle,
Δt_{u_N} is a period in which the corresponding device is in the operating state in which the signal can be transmitted in the N-th transmission/reception cycle, and
Δt_{access} is a propagation time of the signal in one direction between the other communication device and the corresponding device.

### (Supplementary Note 11)

The communication device described in Supplementary Note 2 in which the transmission timing is a timing at which the signal is transmitted in the N-th transmission/reception cycle during the time from a transmission start time T_{wakeup_N}+Δt_{wakeup}−Δt_{access} to a transmission end time T_{wakeup_N}+Δt_{wakeup}+Δt_{d_u_N}−Δt_{access}.

Where,
T_{wakeup_N} is a start time of a start-up state of the corresponding device in the N-th transmission/reception cycle in which a transition is made from the idle state to the operating state,
Δt_{wakeup} is a period in which the corresponding device is in the start-up state,
Δt_{d_u_N} is a period in which the corresponding device is in the operating state in which the signal can be transmitted and received in the N-th transmission/reception cycle, and
Δt_{access} is a propagation time of the signal in one direction between the other communication device and the corresponding device.

### (Supplementary Note 12)

The communication device described in Supplementary Note 4 in which the transmission timing is a timing at which the signal is transmitted in the N-th transmission/reception cycle during the time from a transmission start time T_{wakeup_N}+Δt_{wakeup}−Δt_{d_N} to a transmission end time T_{wakeup_N}+Δt_{wakeup}+Δt_{d_N}+Δt_{u_N}.

Where,
T_{wakeup_N} is a start time of a start-up state of the other communication device in the N-th transmission/reception cycle in which a transition is made from the idle state to the operating state,
Δt_{wakeup} is a period in which the other communication device is in the start-up state,
Δt_{d_N} is a period in which the other communication device is in the operating state in which the signal can be received in the N-th transmission/reception cycle, and
Δt_{u_N} is a period in which the other communication device is in the operating state in which the signal can be transmitted in the N-th transmission/reception cycle.

### (Supplementary Note 13)

The communication device described in Supplementary Note 4 in which the transmission timing is a timing at which the signal is transmitted in the N-th transmission/reception cycle during the time from the transmission start time T_{wakeup_N}+Δt_{wakeup}+Δt_{u_N}−Δt_{access} to the transmission end time T_{wakeup_N}+Δt_{wakeup}+Δt_{u_N}+Δt_{d_N}−Δt_{access}

Where,
T_{wakeup_N} is a start time of a start-up state of the other communication device in the N-th transmission/reception cycle in which a transition is made from the idle state to the operating state,
Δt_{wakeup} is a period in which the other communication device is in the start-up state,
Δt_{d_N} is a period in which the other communication device is in the operating state in which the signal can be received in the N-th transmission/reception cycle,
Δt_{u_N} is a period in which the other communication device is in the operating state in which the signal can be transmitted in the N-th transmission/reception cycle, and
Δt_{access} is a propagation time of the signal in one direction between the corresponding device and the other communication device.

### (Supplementary Note 14)

The communication device described in Supplementary Note 4 in which the transmission timing is a timing at which the signal is transmitted in the N-th transmission/reception cycle during the time from the transmission start time T_{wakeup_N}+Δt_{wakeup}−Δt_{access} to the transmission end time T_{wakeup_N}+Δt_{wakeup}+Δt_{d_u_N}−Δt_{access}.

Where,
T_{wakeup_N} is a start time of a start-up state of the other communication device in the N-th transmission/reception cycle in which a transition is made from the idle state to the operating state,
Δt_{wakeup} is a period in which the other communication device is in the start-up state,
Δt_{d_u_N} is a period in which the other communication device is in the operating state in which the signal can be transmitted and received in the N-th transmission/reception cycle, and
Δt_{access} is a propagation time of the signal in one direction between the corresponding device and the other communication device.

### REFERENCE SIGNS LIST

1 Terminal device
2 Terminating device
3 Transmission line
4 Switch
5 Light splitter
11 Network interface unit
12 Buffer unit
13 Signal superimposing/separating unit
14 Communication control unit
15 User apparatus interface unit
16 Operation/measurement unit
21 Network interface unit
22 Buffer unit
23 Signal superimposing/separating unit
24 Communication control unit
25 Upper apparatus interface unit
26 Calculation unit

1. A communication device comprising:
a processor; and
a storage medium having computer program instructions stored thereon, when executed by the processor, perform to:
transmit and receive a signal to and from another communication device; and
switch from an idle state to an operating state by a reception timing of the signal, transmit the signal while in the operating state, and switch from the operating state to the idle state after transmission/reception of the signal is performed.

2. The communication device according to claim 1, wherein the computer program instructions further perform to
superimpose control information on the signal,
calculates a transmission timing of the other communication device for the signal to receive the signal at the reception timing, and
superimposes the control information indicating the transmission timing on the signal.

3. The communication device according to claim 1, wherein the computer program instructions further perform to
acquire control information superimposed on the signal transmitted from the other communication device, and
specifies the reception timing based on the transmission timing of the other communication device for the signal included in the control information.

4. A communication device comprising:
a processor; and
a storage medium having computer program instructions stored thereon, when executed by the processor, perform to:
transmit and receive a signal to and from another communication device; and
transmit the signal at a transmission timing determined such that a reception timing of the other communication device for the signal is a timing at which the other communication device can receive the signal.

5. The communication device according to claim 4, wherein the computer program instructions further perform to
acquire control information superimposed on the signal transmitted from the other communication device, and
transmit the signal at the transmission timing based on the control information.

6. The communication device according to claim 4, wherein the computer program instructions further perform to
superimpose control information including information indicating the transmission timing on the signal.

7. A communication control method comprising:
transmitting and receiving a signal to and from another communication device; and
switching a corresponding device from an idle state to an operating state by a reception timing of the signal, causing the corresponding device to transmit the signal while the corresponding device is in the operating state, and switching the corresponding device from the operating state to the idle state after transmission/reception of the signal is performed.

8. (canceled)
